(19) United States
(12) Patent Application Publication
(10) Pub. No.: US 2009/0159353 A1
(43) Pub. Date: Jun. 25, 2009

(54) RADIATOR ASSEMBLY FOR AN AUTOMOTIVE VEHICLE, AUTOMOTIVE VEHICLE AND METHOD FOR MOUNTING A RADIATOR ASSEMBLY ON A BODY STRUCTURE OF AN AUTOMOTIVE VEHICLE

(75) Inventor: Richard KERKEWITZ, Klein-Winternheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/340,623

(22) Filed: Dec. 19, 2008

(30) Foreign Application Priority Data
Dec. 22, 2007 (EP) 07025071.7-2422

(51) Int. Cl. B60K 11/04; F16B 2/00

(52) U.S. Cl. 180/68.4; 403/24

(57) ABSTRACT

A radiator assembly for an automotive vehicle is provided that includes, but is not limited to a radiator of a radiator unit and at least one decoupling element for fixing the radiator to a vehicle body structure. The at least one decoupling element is connected to the radiator and comprises a first section contained in the radiator unit and a second section protruding from the radiator unit, a junction plane between the first section and the second section being designed as a weak link.

### CROSS-REFERENCE TO RELATED APPLICATION

This application claims priority to European Patent Application No. 07025071.7-2422, filed Dec. 22, 2007, which is incorporated herein by reference in its entirety.

### TECHNICAL FIELD

The invention relates to a radiator assembly for an automotive vehicle. It further relates to an automotive vehicle with a radiator assembly and to a method for mounting a radiator assembly on a body structure of an automotive vehicle.

### BACKGROUND

A radiator unit is mounted on the body structure of an automotive vehicle by means of a number of support members. Documents U.S. Pat. No. 4,579,184 and DE 39 26 568 C1 disclose support members being designed as pins protruding from the radiator unit and being contained in a retaining structure of a vehicle body structure, thereby fixing the radiator unit to the vehicle body structure.

In case of an accident with damage to the front-end of the vehicle, the radiator unit is pushed back towards the engine and breaks the pins. As a consequence, to repair the damage, a replacement of the radiator unit as a whole or a complex replacement of the broken pins is necessary.

The document DE 601 17 740 T2 discloses a fastening structure to attach the radiator unit to a frame which itself is attached to the vehicle body structure, where the fastening structure comprises a contact part made of elastomer designed to be interposed between the radiator unit and the frame. If in the case of an accident the radiator unit is pushed back towards the engine, the radiator unit is non-destructively detached from the frame by means of the contact part.

However, the possibility of damage to the radiator unit or the frame cannot be eliminated completely in this case, since the non-destructive detachment may not work fast enough in any case. Consequently, existing radiator units are expensive to repair in case of an accident and therefore cause high insurance costs.

It is, therefore, at least one object of the present invention, to provide a radiator assembly, which does not need to be repaired expensively after being pushed back towards the engine in case of an accident. It is a further object of the present invention, to provide a method for mounting a radiator assembly on a body structure of an automotive vehicle in order to provide an attachment of the radiator assembly to the body structure which can be repaired easily. Moreover, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics, are solved by a radiator assembly for an automotive vehicle. The radiator assembly in accordance with an embodiment of the invention comprises a radiator unit and at least one decoupling element for fixing the radiator unit to a vehicle body structure. The at least one decoupling element is connected to the radiator unit and comprises a first section contained in the radiator unit and a second section protruding from the radiator unit. A junction plane between the first and the second section is designed as a weak link. Typically, there are provided several decoupling elements in order to fix the radiator unit securely in the engine compartment of the vehicle.

According to an embodiment of the invention, the decoupling elements provide the link between the radiator unit and the vehicle body structure. They are called “decoupling elements” all the same, because in the case of an accident and the radiator being pushed back towards the engine, they permit the decoupling of the radiator unit from the vehicle body structure. Since the junction plane between the first and the second section is designed as a weak link, the decoupling elements break in this plane due to shear forces acting on the decoupling element, and the radiator unit itself is not damaged.

Therefore, the decoupling elements according to an embodiment of the invention are designed to be destroyed in case of an accident. They may, however, be replaced easily and inexpensively due to the fact that they are not formed in one piece with parts of the radiator. In fact, the decoupling elements are separate pieces preferably formed of a plastic material, e.g., an elastomer, which can be replaced without difficulty. According to one embodiment of the invention, a grommet, e.g. a rubber grommet, is provided as decoupling element.

Preferably, the first section of the at least one decoupling element is contained in a first retaining structure inside a radiator tank and the first section of the at least one decoupling element is designed to be connected with positive locking to the first retaining structure. This enables on one hand a secure attachment of the decoupling element to the radiator unit and defines on the other hand a weak link, namely the junction plane between the first and the second section separating the section inside the radiator unit from the section outside, along which the decoupling element may break in case of an accident. It is a further advantage of this embodiment that it saves space which may be scarce in the engine compartment of an automotive vehicle.

According to an embodiment of the invention, an automotive vehicle comprises a radiator assembly as just described. At least one part of the second section of the at least one decoupling element is contained in a second retaining structure of a vehicle body structure, thereby fixing the radiator assembly to the vehicle body structure. According to one embodiment, the at least one part of the second section is designed to be connected with positive locking to the retaining structure of the vehicle body structure.

A method for mounting a radiator assembly on a body structure of an automotive vehicle according to the invention comprises the steps of providing a radiator unit comprising at least one first retaining structure for receiving a first section of a decoupling element; providing a vehicle body structure comprising at least one second retaining structure for receiving a second section of the decoupling element; providing at least one decoupling element comprising a first section and a second section, a junction plane between the first and the second section being designed as a weak link; inserting the first section of the at least one decoupling element into the first retaining structure and the second section into the second retaining structure.

The radiator assembly and the method according to the invention enable a very simple and inexpensive repair of the radiator assembly in case of an accident due to the fact, that only the destroyed separate decoupling elements must be replaced. Providing the weak link in the decoupling elements prevents damage of the radiator itself.

### BRIEF DESCRIPTION OF THE DRAWINGS

The present invention will hereinafter be described in conjunction with the following drawing figures, wherein like numerals denote like elements, and

FIG. 1 shows schematically a radiator unit according to the prior art;

FIG. 2 shows schematically a radiator assembly according to an embodiment of the present invention; and

FIG. 3 shows schematically a radiator assembly according to another embodiment of the present invention.

### DETAILED DESCRIPTION

The following detailed description is merely exemplary in nature and is not intended to limit application and uses. Furthermore, there is no intention to be bound by any theory presented in the preceding background and summary or the following detailed description.

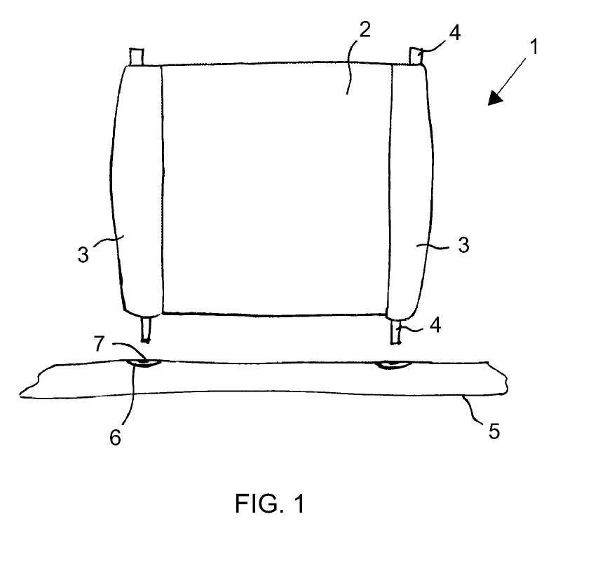

FIG. 1 illustrates a radiator unit 1 comprising a radiator 2, supply means (not shown) and a radiator tank 3. The radiator unit 1 is attached to a vehicle body structure 5 by means of metal pins 4 protruding from the radiator 2 or the radiator tank 3 and being formed in one piece with parts of the radiator tank 3 or being rigidly coupled to the radiator tank 3. In order to attach the radiator unit 1 to the vehicle body structure 5, a rubber element 6 with a receiving portion 7 is provided in the vehicle body structure 5, the receiving portion 7 receiving the protruding pins 4. In case of an accident, the radiator 2 is pushed back towards the engine and the pins 4 tend to break or at least bend due to the force exerted on them.

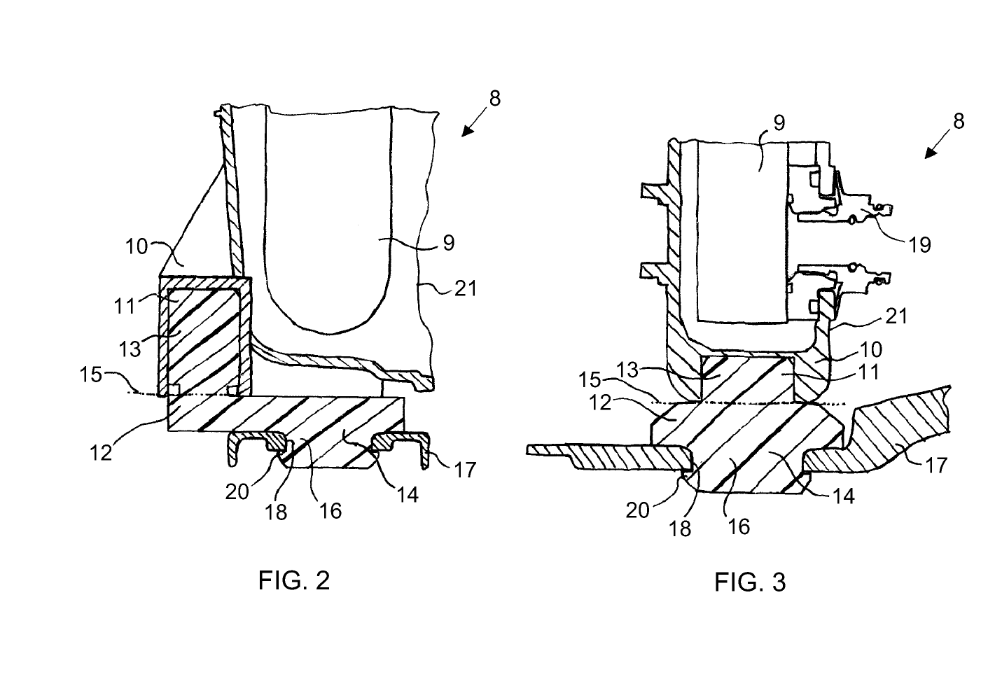

FIG. 2 illustrates a cross section of a radiator assembly 8 according to one embodiment of the present invention. The radiator assembly 8 comprises a radiator unit 21 with a radiator 9, a radiator tank 10 and supply means (not shown). It further comprises decoupling elements 12 to attach the radiator assembly 8 to a vehicle body structure 17.

In this embodiment, rubber grommets are used as decoupling elements 12. The decoupling elements 12 comprise a first section 13, which is mounted in a first retaining structure 11 inside the radiator tank 10. They further comprise a second section 14 protruding from the radiator tank 10. A junction plane 15 between the first section 13 and the second section 14 is designed as a weak link. Thus, a part of the decoupling elements 12, namely the first section 13, is contained inside the radiator tank 10, thereby providing a reliable and space-saving fastening of the radiator assembly 8.

At least a part 16 of the second section 14 of the decoupling elements 12 is contained in a second retaining structure 18 assigned to the vehicle body structure 17. In the embodiment shown in FIG. 2, the decoupling element 12 has anchor means 20 to fix the decoupling element 12 to the vehicle body structure 17. The first section 13 as well as the second section 14 are connected with positive locking to the first retaining structure 11 and the second retaining structure 18, respectively. In case of an accident with damage to the front-end of the vehicle, the radiator assembly 8 is pushed back towards the engine (not shown) and therefore moves with respect to the vehicle body structure 17.

Due to the exerted force the first section 13 of the decoupling element 12 contained in the first retaining structure 11 is sheared off essentially along the junction plane 15 or shearing plane, which defines a weak link of the radiator assembly 8. While a part of the decoupling element, namely the second section 14, remains with the vehicle body structure 17, the first section 13 remains with the radiator 9. The radiator 9 itself is in most cases of minor accidents not damaged at all, but may be put back in place by a simple and inexpensive repair. In order to repair the radiator assembly 8, the remains of the decoupling element 12 are disposed of and a new decoupling element 12 is inserted.

FIG. 3 shows a cross-sectional view of a radiator assembly 8 according to another embodiment of the present invention. In principle, the radiator assembly 8 according to FIGS. 2 and 3 correspond to each other, whereas in FIG. 3 supply units 19 of the radiator 9 are shown schematically. In FIG. 3 it is shown, that the decoupling element 12 may take a form adapted to that of the first retaining structure 11, of the second retaining structure 18 and to the general outline of the radiator 9.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A radiator assembly for an automotive vehicle, comprising
a radiator of a radiator unit; and
at least one decoupling element adapted to fix the radiator to a vehicle body structure; the at least one decoupling element comprising:
a first section contained in the radiator unit,
a second section protruding from the radiator unit, and
a junction plane between the first section and the second section is designed as a weak link.

2. The radiator assembly according to claim 1, wherein the at least one decoupling element is formed of a plastic material.

3. The radiator assembly according to claim 2, wherein the at least one decoupling element is formed of an elastomer.

4. The radiator assembly according to claim 1, wherein the at least one decoupling element is a grommet.

5. The radiator assembly according to claim 1, wherein the first section is contained in a first retaining structure inside a radiator tank.

6. The radiator assembly according to claim 5, wherein the first section of is adapted to connect to the first retaining structure with positive locking.

7. The radiator assembly according to claim 1, wherein at least one part of the second section of is contained in a second retaining structure of the vehicle body structure to fix the radiator assembly to the vehicle body structure.

8. The radiator according to claim 7, wherein the at least one part of the second section is designed to be connected with positive locking to the second retaining structure of the vehicle body structure.

9. A method for mounting a radiator assembly on a body structure of an automotive vehicle, comprising the steps of
providing a radiator unit comprising at least one first retaining structure for receiving a first section of a decoupling element;
providing a vehicle body structure comprising at least one second retaining structure for receiving a second section of the decoupling element;
providing at least one decoupling element comprising the first section and the second section, a junction plane between the first section and the second section being designed as a weak link; and
inserting the first section of the at least one decoupling element into a first retaining structure and the second section into a second retaining structure.

10. The method according to claim 9, wherein the at least one decoupling element is formed of a plastic material.

11. The method according to claim 10, wherein the at least one decoupling element is formed of an elastomer.

12. The method according to claim 10, further comprising a step of providing a grommet as the at lease one decoupling element.

13. The method according to claim 9, wherein the first section of the at least one decoupling element is connected with a positive locking to the first retaining structure

14. The method according to claim 9, wherein at least one part of the second section is connected with positive locking to the second retaining structure of the vehicle body structure.
